(19) United States
(12) Patent Application Publication
(10) Pub. No.: US 2003/0187077 A1
(43) Pub. Date: Oct. 2, 2003

(54) Colloidal dispersion of a cerium compound or compound of cerium and at least one other element selected from rare earths and transition metals and comprising an amino acid

(76) Inventor: Jean-Yves Chane-Ching, Eaubonne (FR)

Correspondence Address: Jean-Louis Seugnet, Intellectual Property Dept, Rhodia Inc, 259 Prospect Plains Road, Cranbury, NJ, 08512-7500, US

(21) Appl. No.: 10/297,264

(22) PCT Filed: Jun. 1, 2001
(86) PCT No.: PCT/FR01/01706

(30) Foreign Application Priority Data
Jun. 5, 2000 (FR) 00/07147

(51) Int. Cl. C08L 1/00

(52) U.S. Cl. 516/31

(57) ABSTRACT

The invention concerns a colloidal dispersion of a cerium compound or of a cerium compound and at least another element selected among titanium, vanadium, chromium, manganese, iron, cobalt, nickel, copper, zinc, aluminum, gallium, zirconium and rare earths other than cerium. The invention is characterised in that it comprises an amino acid, said acid being at least bound to particles constituting the dispersion. Said dispersion can be used on a substrate as anticorrosive agent, for preparing polymer films, in a cosmetic composition, in catalysis particularly for motor vehicle post-combustion catalysis, for lubrication and in ceramics.

The present invention relates to a colloidal dispersion of a cerium compound or a compound of cerium and at least one other element selected from rare earths and transition metals and comprising an amino acid.

Cerium sols, more particular sots of tetravalent cerium, are well known. Further, cerium sols in combination with a further element may be highly advantageous, for example for applications in cosmetics, as an anti-UV agent, in optics or in the luminophore field.

Because of their numerous potential applications, functionalisable sots are also being researched, i.e., sols with a reactive function for further chemical treatment, this further treatment possibly endowing the sols with specific properties such as compatibility with polymer matrices.

It is also important to have available colloidal dispersions with a low acidity pH. Known processes for producing such dispersions, such as that described in European patent EP-A-0 700 870, are processes comprising a relatively large number of steps. It would be advantageous to have simpler processes available.

The dispersions of the invention satisfy the needs mentioned above.

To this end, the colloidal dispersion of the invention is a dispersion of a cerium compound or a compound of cerium and at least one other element M selected from titanium, vanadium, chromium, manganese, iron, cobalt, nickel, copper, zinc, aluminium, gallium, zirconium and rare earths other than cerium, and is characterized in that it comprises an amino acid, this acid being at least partially bound to the constitutive particles of the dispersion.

Other characteristics, details and advantages of the invention will become apparent from the following description and non-limiting examples given by way of illustration.

Throughout the remainder of the description, the expression “colloidal dispersion or sol of a cerium compound or of a compound of cerium and another said element” means any system constituted by fine solid particles with colloidal dimensions based on an oxide and/or hydrated oxide (hydroxide) of cerium and the other element, in suspension in a liquid phase, said species also optionally containing residual quantities of bound or adsorbed ions such as acetates, citrates, nitrates, chlorides or ammonium ions. The percentage of said bound ions X or possibly X+Y in the case of two ions, expressed as the mole ratio X/Ce or (X+Y)/Ce can, for example, be in the range 0.01 to 1.5, more particularly in the range 0.01 to 1. It should be noted that in such dispersions, the cerium and the other element can be either completely in the form of colloids or simultaneously in the form of ions or polyions and in the form of colloids.

The term “rare earth” means elements from the group constituted by yttrium and elements from the periodic table with atomic numbers in the range 57 to 71 inclusive.

The principal characteristic of the dispersion of the invention is that it comprises an amino acid at least partially bound to the colloidal particles. The term “bound” means that there is a bond between the amino acid and the particles. This bond can be of several different types. Firstly, it may be a bond formed by chemical complexing between the acid group of the amino acid in the ionised form and a cation present on the surface of the colloidal particle. This bond may also be electrostatic in nature, between the ionised COO⁻ moiety of the amino acid and the surface of the colloidal particle with a positive charge. Finally, the bond can be made by adsorption between the amino acid and the surface of the particle. It should be noted that the three types of bonds given above may co-exist. These bonds can also be demonstrated by different techniques, for example by determining adsorption curves using techniques that are known to the skilled person, by chemical analysis of the centrifugation or ultracentrifugation supernatants, or by spectroscopic Raman or infrared type techniques carried out on the colloids separated from their liquid phase by ultracentrifuging.

Depending on the bond as described above between the amino acid and the particles, the NH₂ function of the acid may be free and thus constitutes a protonisable function improving the colloidal stability of the dispersion, or the function per se may have some chemical reactivity for a subsequent treatment.

Preferably, the amino acid is, as far as possible, present in the form that is bound to the particles as just described. Preferably, at least 50 mole % and more preferably at least 75 mole % of the amino acid is present in the bound form.

More particularly, the amino acid is an aliphatic amino acid. In particular, it is a C₄-C₁₀ acid, preferably a C₄-C₈ acid. It should be noted that the longer the chain, the more hydrophobic the particles and this may adversely affect the stability of the dispersion in the case of aqueous dispersions.

The total amino acid content in the dispersion is generally in the range 0.1 to 1 mole of amino acid per mole of cerium.

A further feature of the dispersion is that it can optionally contain cerium in oxidation state III. In this case, the amount of cerium III is generally at most 50%. It is expressed here and throughout the description as the CeIII/total Ce atomic ratio. More particularly, the cerium III content is at most 35%, especially in the case of a dispersion of cerium and a further element M, and more particularly at most 10%. Further, it is preferably at least 0.5%. More particularly still, this amount is at least 1%, still more particularly at least 1.5%. In this case, the dispersion also contains cerium in the cerium IV form. The invention is also, of course, applicable to the case where the cerium is present in the cerium IV form.

In the case of a dispersion containing an element M, the quantity of this element is generally at most 50%, preferably at most 20%, this quantity being expressed as the ratio of the number of moles of element M/sum of the moles of element M and cerium. Element M can be present in different oxidation states. Clearly, the invention is applicable to dispersions containing a plurality of elements M.

The pH of the dispersions of the invention can vary widely, in particular in the high pH range. As an example, the pH can be in the range 4 to 8.5. These pH values of close to neutrality mean that applications for the dispersions of the invention are of interest.

In a further variation, the dispersions of the invention are particularly pure as regards nitrate anions. More precisely, the nitrate anion content in dispersions of this variation, measured by the weight content of the nitrate anions in the colloidal particles, is less than 80 ppm. The dispersions of the invention can also be pure as regards their chloride ion content.

In a further feature, the concentration of the dispersion of the invention is at least 50 g/l. This concentration is expressed as the oxide and takes into account the sum of the oxides of cerium and, if necessary, the other element(s) cited above. More particularly, this concentration is at least 80 g/l.

The size of the colloidal particles that constitute the sols of the invention can also vary within a wide range. The mean diameter of the particles can in particular be in the range 2 to 80 nm, more particularly in the range 3 to 50 μm. This diameter is determined by photometric counting using a HRTEM analysis (high resolution transmission electron microscope).

Finally, the dispersions of the invention can be aqueous dispersions, the continuous phase being water, or dispersions in a continuous phase that can be constituted by a water/water-miscible organic solvent mixture or dispersions in an organic water-miscible solvent.

Examples of solvents that can be cited are alcohols such as methanol or ethanol, glycols such as ethylene glycol, acetate derivatives of glycols such as ethylene glycol monoacetate, glycol ethers, polyols or ketones.

The process for preparing the dispersions of the invention will now be described.

This process essentially consists of adding an amino acid to a starting colloidal dispersion of a cerium compound or a compound of cerium and at least one other said element M.

The amino acid can be added in the solid or dissolved form.

The quantity of amino acid added is adjusted as a function of the size of the colloidal s particles and thus their specific surface area. The larger the surface area, the more amino acid is added to provide a large proportion of acid in the bound form. Preferably, a quantity of 2 to 8, more particularly 2 to 5 molecules of amino acid per nm² of surface area of colloidal particles is envisaged.

The amino acid is normally added at ambient temperature with stirring. Stirring can be maintained after addition.

Any suitable colloidal dispersion can be used as the starting dispersion. Suitable dispersions that can be mentioned are those described or obtained by the processes described in the following European patents: EP-A-0 206 906, EP-A-0 208 580, EP-A-0 208 581, EP-A-0 239 477 and EP-A-0 700 870. More particularly, colloidal dispersions obtained by thermohydrolysis of an aqueous solution of a cerium IV salt such as the nitrate, in particular in an acidic medium, can be used. Such a process has been described in European patent applications EP-A-0 239 477 and EP-A-0 208 580. It is possible to start from dispersions that have already been purified or dispersions with a high pH. These dispersions, purified before adding the amino acid or with a high pH, may have been obtained by treating with a cationic and/or anionic resin as described in EP-A-0 700 870 cited above.

A process for preparing sols that can contain cerium III and/or a said element M will be described, which can then be used as starting products to obtain the dispersions of the invention which will also contain the amino acid.

This process for preparing the dispersions based on cerium and an element M comprises a first step in which a mixture of at least one cerium salt with at least one salt of element M is reacted with a base. For dispersions containing cerium III, a cerium III salt can be used, or a mixture comprising a cerium IV salt as well as the cerium III salt.

More particular cerium III salts that can be used are the acetate, chloride or nitrate and mixtures of these salts such as acetate/chloride mixtures. For cerium IV, cerium IV nitrate can be used, with chlorides and nitrates for the other elements. The same salt types can be used for the other elements M.

In particular, the base can be a hydroxide. Alkali hydroxides or alkaline-earth hydroxides and ammonia can be cited. It is also possible to use secondary, tertiary or quaternary amines. However, the amines and ammonia can be preferred provided that they reduce the risk of pollution by the alkali or alkaline-earth cations. Urea can also be used.

In a particular feature of the process, the cerium salt is reacted with the base in the presence of an acid.

Suitable acids that can be mentioned are mineral acids, more particularly those corresponding to cerium salts, in particular cerium III, used in the reaction. Acetic acid, nitric acid or hydrochloric acid can be cited in this regard.

It should be noted that the acid can also be provided by the solution of the salt into which it is incorporated. As an example, it is possible to use a solution of acidic titanium chloride such as TiOCl₂,2HCl as the starting solution.

The quantity of acid present or employed in the reaction is such that the atomic ratio H+/(Ce+M) is more than 0.1, preferably 0.25.

The reaction of the base with the salts can be carried out continuously, meaning simultaneous addition of the reactants to the reaction medium.

The pH of the reaction medium is normally in the range 7.5 to 9.5. The conditions can be such that the pH of the reaction medium is kept constant during the reaction.

A precipitate is obtained at the end of the reaction. This precipitate can be separated from the liquid medium using any known method, for example centrifuging. The precipitate obtained can then be taken up into suspension in water to produce the dispersion of the invention. The cerium concentration in the dispersion obtained is generally in the range 0.005 M to 2 M, preferably in the range 0.05 M to 0.25 M.

Advantageously, the precipitate from the reaction is washed. Washing can be carried out by adding the precipitate to water then, after stirring, by separating the solid from the liquid medium, for example by centrifuging. This operation can be repeated a number of times if required.

In a variation, the dispersion obtained after taking up into suspension in water can be purified and/or concentrated by ultrafiltration.

Washing and ultrafiltration can be carried out in air or in an atmosphere of air and nitrogen, or in nitrogen. The atmosphere in which these operations are carried out plays a role in transforming cerium III to cerium IV.

After suspending in water and after the optional washing step, and preferably before the concentration step if concentration is carried out, it may be advantageous to oxidise the dispersion; this further improves the stability of the dispersion. This oxidising treatment can be carried out in two manners, for example.

Firstly, the dispersion is stirred in air for a period of 3 to 20 hours, for example. Secondly, hydrogen peroxide can be added to the dispersion. The quantity of hydrogen peroxide added is adjusted so as to obtain the CeIII/total Ce ratio given above in the final dispersion. This oxidation by adding hydrogen peroxide is preferably carried out after stirring the dispersion in air for a period of more than 2 hours. The period for adding hydrogen peroxide can be in the range 30 min to 6 hours.

The process described above for preparing a dispersion of cerium and a further element M can be employed when preparing a dispersion of cerium alone in which the cerium is partially in the Ce III form. In this case, the first step of the process consists of reacting the base with a cerium III salt alone in the presence of an acid. The above description is applicable in this case; the quantity of acid, measured here by the H⁺/Ce ratio, satisfies the values given above.

This process, both for the case of a starting dispersion of cerium alone and for that of a starting dispersion of cerium and a further element M, can produce sols with a conductivity of at most 5 mS/cm, which is characteristic of high purity, and a nitrate content of less than 80 ppm.

As can be seen, the above process advances from forming a precipitate that is then re-dispersed in water to produce the starting dispersion. It should be noted that it is possible to add the amino acid at the moment when water is added to re-disperse the precipitate. This manner of manufacture can directly produce concentrated dispersions without the need for a concentration step, for example ultrafiltration.

After adding the amino acid, it is possible to purify the colloidal dispersion of the free amino acid, not bound to colloidal particles; this purification can be carried out by ultrafiltration, for example.

It is also possible to treat the dispersion with a resin to increase its pH.

Preferably, strongly basic anionic resins are used.

Examples of resins of this type that can be mentioned are those with a styrene-divinylbenzene copolymer backbone. More particularly, those with quaternary ammonium or OH⁻ functional groups can be mentioned. Examples of anionic resins that can be used are Amberlite IRN 78® or Duolite A 101® resins.

The resin treatment can be carried out in any suitable manner. The resins can be brought into direct contact with the colloidal dispersion.

The quantity of anionic resin to be used is defined by the pH to be obtained.

One of the advantages of the dispersions of the invention is the possibility of producing a dispersion with a high pH by treatment with an anionic resin wherein the duration or the number of the steps is reduced.

It is also possible to increase the pH of the dispersions of the invention as obtained by the processes described above by adding a base such as ammonia.

In the case of a dispersion that is partially or completely in a solvent medium other than water, this dispersion can be prepared from an aqueous dispersion such as that obtained using the processes described above and by adding an organic solvent to the aqueous dispersion followed by distilling to eliminate the water or treatment with an ultrafiltration membrane for gradual water elimination.

The dispersions of the invention can also produce re-dispersible compositions in the form of colloidal dispersions.

To obtain such a re-dispersible composition, a dispersion of the invention undergoes evaporation, centrifuging, ultrafiltration or osmotic compression. Osmotic compression is a known method; the principle consists of balancing the chemical potential of water through a membrane.

The colloidal dispersion is placed in a dialysis bag, for example of cellulose material, and the bag is placed in an aqueous solution with a chemical potential of water that is different from that of the aqueous phase of the dispersion. An aqueous polyethylene glycol (PEG) solution or dextran solution can be used. The concentration of PEG or dextran fixes the osmotic pressure and thus the final concentration of the colloidal dispersion.

Evaporation, centrifuging and ultrafiltration can be carried out using any suitable apparatus. Preferably, the dispersion is oven dried at low temperature, preferably at a temperature of less than 50° C., or using a rotary evaporator, drying preferably being carried out on dispersions after purifying them of free, non-bound amino acid.

The treatments that have just been described are carried out alone or in combination and enable the colloidal gel to change smoothly into a gel or paste and then a powder. This paste or powder can optionally be dried.

A re-dispersible composition is then obtained in the form of a colloidal dispersion, which comprises particles based on cerium or cerium and an element M as defined above and an amino acid at least partially bound to said particles. The cerium and the other element can be in the form of an oxide and/or a hydrated oxide (hydroxide). The other features described above, in particular with respect to the amino acid and its bond with the particles or with respect to the element M, are also applicable to this composition. As indicated above, the composition can be in the form of a gel, a paste or a powder.

This composition can be re-dispersed in a liquid medium to produce a colloidal dispersion identical to the colloidal dispersion of the invention described above.

The dispersions of the invention can be used in many applications. Catalysis can be cited, in particular for automobile exhausts, in which case the dispersions are used to prepare the catalysts. The dispersions can also be used for lubrication, in ceramics. In producing luminophore compounds or in optics. The dispersions can also be used for their anti-UV properties, for example for preparing films of polymers (acrylics or polycarbonates, for example) or cosmetic compositions, in particular for preparing anti-UV creams. Finally, they can be used on a substrate as anti-corrosive agents.

Examples will now be given.

### EXAMPLE 1

A colloidal dispersion of CeO₂ with a colloidal diameter of 5 nm was obtained by adding 1400 g of demineralised water to 460 g of a cerium compound obtained by thermohydrolysis at 100° C. of a pre-neutralised ceric nitrate solution using the process described in Example 1 of European patent application EP-A-0 208 580. The ensemble was stirred. The CeO₂ concentration in the dispersion was 1 M.

A solution A was prepared by dissolving 39.3 g of 6-aminocaproic acid (i.e., 0.3 moles of amino acid with a molecular weight of 131.2 g) in demineralised water, made up to 150 cm³. Solution A was added at ambient temperature, at a constant rate, over one hour to 1000 ml of the stirred CeO₂ colloidal dispersion described above.

The dispersion was stirred for 2 hours.

40 g of moist Amberlite IRN 78 anionic resin from Prolabo was added to a 200 cm³ aliquot of the dispersion over forty minutes.

The product was filtered through a frit under high vacuum.

The pH of the dispersion was 4 and its equivalent concentration of CeO₂, determined by oven drying and calcining a sample, was 0.98 M.

### EXAMPLE 2

An aqueous colloidal dispersion of CeO₂ that was free of nitrate ions was prepared as follows.

416.5 g of cerium (III) acetate with 49.29% of oxide CeO₂ (i.e., 1.19 moles of Ce) then 144 g of concentrated acetic acid (i.e., 2.4 moles of CH₃COOH) diluted by adding 100 ml of demineralised water were placed in a beaker. Stirring was commenced. 2000 ml of demineralised water was then added. The ensemble was stirred until a solution that was clear to the eye was obtained. The concentration of the mixture obtained was about 0.5 M of Ce and the (H/Ce) mole ratio was 2.

The solid was precipitated in a continuous apparatus comprising:

a one litre reactor provided with a paddle stirrer with an initial stock of water and an electrode provided with a pH regulating pump set to a reference value of 8.7;

two supply flasks, one containing the cerium salt solution described above and the other containing a 10 N ammonia solution.

2400 ml of the cerium acetate solution and 2900 ml of 3 N ammonia were then added over 270 min.

The precipitate was separated from the mother liquor by centrifuging at 4500 rpm for 10 minutes. By calcining a sample at 1000° C., the CeO₂ percentage of the precipitate was determined to be 23.4% of oxide CeO₂.

The precipitate was dispersed by adding demineralised water to obtain a dispersion of 0.25 M of Ce. It was stirred for 15 min. It was centrifuged once more. Two successive operations were then carried out.

100 ml of the 0.25 M Ce dispersion was diluted to 300 ml with demineralised water. Ultrafiltration through 3 kD membranes resulted in concentration to 100 ml. Three ultrafiltration steps were then carried out to obtain a 0.12 M Ce colloidal dispersion with a clear appearance. The pH of the dispersion was 3.5.

The NO₃ content was less than 80 ppm. The Ce III/total Ce ratio was 1.9% and the conductivity of the dispersion was 0.9 mS/cm. The colloidal size was 3 nm.

0.188 g of 6-aminocaproic acid (1.4 millimoles) was added to 20 cm³ of the 0.12 M CeO₂ dispersion (2.4 millimoles) and stirring was continued for 2 hours. The pH of the dispersion was 4.6.

5 cm³ of 0.1 M NH₄OH was added to the dispersion at a controlled rate over 10 min. The pH was 7.

### EXAMPLE 3

An aqueous colloidal dispersion of cerium and lanthanum particles was obtained as follows.

A solution A was obtained by adding 525.6 g of Ce(CH₃COO)₃ containing 49.3% of CeO₂ to water and making up to 3000 ml. A solution B was obtained by adding 135 g of lanthanum acetate containing 46.4% of La and making up to 750 ml. A solid residue was separated by centrifuging at 4500 rpm for 10 min. Solution B was added to solution A, then 214.8 cc of 17.5 M acetic acid solution was added.

The solid was precipitated in a continuous apparatus comprising:

a one litre reactor provided with a paddle stirrer with an initial stock of water and a monitoring electrode;

two supply flasks, one containing the cerium and lanthanum salt solutions described above and the other containing a 3 N ammonia solution.

The flow rate of the cerium and lanthanum acetate solution was fixed at about 600 ml/h and the flow rate of the ammonia solution was 336 ml/h.

The pH of the reaction medium was 8.5 throughout the reaction.

A precipitate was obtained that was separated by centrifuging at 4500 rpm for 10 min; the solid product was re-dispersed in demineralised water. Centrifuging was carried out again.

On calcining at 1000° C., the precipitate was evaluated to be 34% of cerium and lanthanum oxide.

The precipitate was dispersed by adding demineralised water to obtain a dispersion with 0.15 M of Ce and La. Stirring was commenced and continued for 15 minutes. Centrifuging was carried out again. Two successive operations were carried out. The dispersion was then stirred in an atmosphere of air overnight. 100 ml of the 0.15 M Ce and La dispersion was diluted to 300 ml using demineralised water. Ultrafiltration using 3 kD membranes concentrated it to 100 ml. Three ultrafiltration steps were carried out to obtain a dispersion containing 0.08 M of CeO₂ and La. The pH was 4.1. The concentration of nitrate ions in the colloidal dispersion was less than 80 ppm. TEM cryometry was used to observe particles with a size of about 3 to 4 nm.

0.12 g of 6-aminocaproic acid (0.9 millimole) was added to 20 cm³ of the above dispersion (1.6 millimoles) and stirring was continued for 2 hours.

The pH was 4.6.

4 cm³ of 0.1 M NH₄OH was added over a period of 8 min.

The pH was 7. The dispersion remained stable over a period of at least 1 month.

### EXAMPLE 4

An aqueous colloidal dispersion of cerium and aluminium particles was obtained as follows.

585 g of 49.3% CeO₂ (1.67 moles of Ce) cerium acetate, 101 g of AlCl₃,9H₂O (Mw=241 g/mole, 0.42 mole of Al) and 103 g of 10 M HCl were placed in a beaker, with stirring, and made up to 3000 ml with demineralised water. The H⁺/(Ce+Al) mole ratio was 0.5.

The solid was precipitated using the continuous apparatus described in Example 2.

2440 ml of this cerium-aluminium acetate solution and 1580 ml of 3 N ammonia were added over 244 min.

The pH of the reaction medium was 8.5 throughout the reaction.

A precipitate was obtained that was separated by centrifuging.

The precipitate was dispersed by adding demineralised water to obtain a dispersion with 0.25 M of Ce and Al. Stirring was commenced and continued for 15 minutes. Centrifuging was carried out again. Two successive operations were carried out. The amount of cerium III in the dispersion was 60%. Dispersion was then stirred in an atmosphere of air overnight. At the end of the treatment, the cerium III content was 31%.

100 ml of the 0.25 M Ce and Al dispersion was diluted to 300 ml using demineralised water. Ultrafiltration using 3 kD membranes concentrated it to 100 ml. Three ultrafiltration steps were carried out to obtain a dispersion containing 0.68 M of CeO₂-AlO_{0.5}. The pH of the dispersion was 4.2.

0.5 g of 6-aminocaproic acid (3.8 millimoles) was added to a first aliquot of 20 cm³ of dispersion (13.6 millimoles). The pH of the dispersion was 4.5.

1 g of 6-aminocaproic acid was added to a second aliquot of 20 cm³ of dispersion. The pH of the dispersion was 4.7.

### EXAMPLE 5

An aqueous colloidal dispersion of cerium and titanium particles was obtained as follows.

562.8 g of 49.3% CeO₂ Ce(CH₃COO)₃ (i.e., 1.6 moles of Ce) and 125 g of 3.19 mole/kg TiOCl₂,2HCl with a density of 1.56 (i.e., 0.4 moles of TiO₂) were stirred. It was made up to 3000 ml with demineralised water. The H⁺/(Ce+Ti) mole ratio was 0.4.

The solid was precipitated continuously in the apparatus described in Example 1.

The pH of the reaction medium was 8.5 throughout the reaction.

A precipitate was obtained that was separated by centrifuging On calcining at 1000° C., the precipitate was evaluated to be 15% of cerium and titanium oxide.

The precipitate was dispersed by adding demineralised water to obtain a dispersion containing 0.12 M of Ce and Ti. Stirring was commenced and continued for 15 minutes. Centrifuging was carried out again. Two successive operations were then carried out. The cerium III content of the dispersion was 60%. The dispersion was then stirred in an atmosphere of air overnight. At the end of the treatment, the cerium III content of the dispersion was 6.5%; the total cerium content was 17.2 g/l.

100 ml of the 0.1 M Ce and Ti dispersion was diluted to 300 ml using demineralised water. Ultrafiltration using 3 kD membranes concentrated it to 100 ml. Three ultrafiltration steps were carried out to obtain a dispersion containing 0.34 M of CeO₂—TiO₂. The pH was 3.8. The concentration of nitrate ions in the colloidal dispersion was less than 80 ppm. TEM cryometry was used to observe particles with a size of about 3 to 4 nm.

0.53 g of 6-aminocaproic acid (4 millimoles) was added to a first aliquot of 20 cm³ of dispersion (6.8 millimoles). The pH of the dispersion was 4.7.

6 cm3 of 0.1 M NH₄OH was added to 10 cm³ of the dispersion obtained over a period of 6 min. The pH was 7.

### EXAMPLE 6

The procedure of Example 3 was followed until a precipitate was obtained that was determined to contain 34% of cerium and lanthanum oxide.

10.1 g of this precipitate (20 millimoles of CeO₂—LaO_{1.5}) was re-dispersed in 50 ml of demineralised water and with 1.6 g of 6-aminocaproic acid (12.2 millimoles). The ensemble was stirred in the open air overnight.

A colloidal dispersion was obtained with a pH of 6.2. the CeO₂—La concentration was 0.4 M. Adding the amino acid simultaneously with taking the precipitate up again into suspension in water resulted in a sol that was more concentrated than that obtained in the case of Example 3.

1. A colloidal dispersion of a cerium compound or a compound of cerium and at least one other element M selected from titanium, vanadium, chromium, manganese, iron, cobalt, nickel, copper, zinc, aluminium, gallium, zirconium and rare earths other than cerium, characterized in that it comprises an amino acid, this acid being at least partially bound to the constitutive particles of the dispersion.

2. A dispersion according to claim 1, characterized in that the amino acid is an aliphatic acid, more particularly a C₄-C₁₀ acid.

3. A dispersion according to claim 1 or claim 2, characterized in that at least mole 50% and more particularly at least 75 mole % of the amino acid is present in the form that is bound to the particles.

4. A dispersion according to any one of the preceding claims, characterized in that it contains cerium III.

5. A dispersion according to any one of the preceding claims, characterized in that it contains a quantity of element M of at most 50% expressed as the ratio of the number of moles of element M/sum of the moles of element M and cerium.

6. A dispersion according to any one of the preceding claims, characterized in that the amount of amino acid is in the range 0.1 to 1 mole of acid per mole of cerium.

7. A dispersion according to any one of the preceding claims, characterized in that its pH is in the range 4 to 8.5.

8. A dispersion according to any one of the preceding claims, characterized in that the continuous phase is water.

9. A dispersion according to any one of claims 1 to 7, characterized in that the continuous phase is constituted by a water/organic water-miscible solvent mixture or by an organic water-miscible solvent.

10. A re-dispersible composition in the form of a colloidal dispersion, characterized in that it comprises particles based on cerium or cerium and an element M selected from titanium, vanadium, chromium, manganese, iron, cobalt, nickel, copper, zinc, aluminium, gallium, zirconium and rare earths other than cerium and an amino acid that is at least partially bound to said particles.

11. A process for preparing a dispersion according to any one of claims 1 to 9, characterized in that the amino acid is added to a starting colloidal dispersion of a cerium compound or a compound of cerium and at least one other said element M.

12. A process according to claim 11, characterized in that after adding the acid, the dispersion is treated with a resin.

13. A process according to claim 11 or claim 12, characterized in that the starting dispersion is obtained by a process in which at least one cerium III salt, if necessary mixed with a salt of said element M, is reacted with a base in the presence of an acid in a quantity such that the mole ratio H⁺/Ce or H⁺/(Ce+M) is more than 0.1, then the precipitate from the preceding reaction is re-dispersed in water.

14. A process according to claim 13, characterized in that the amino acid is added at the time of re-dispersing the precipitate in water.

15. A process according to any one of claims 11 to 14, characterized in that prior to adding the amino acid, the starting dispersion is treated with a resin.

16. A process for preparing a re-dispersible composition according to claim 10, characterized in that the starting product is a dispersion according to any one of claims 1 to 9 or of the type obtained by the process according to any one of claims 11 to 15, and said dispersion is evaporated, centrifuged, ultrafiltered or undergoes osmotic compression.

17. Use of a dispersion of the type defined in any one of claims 1 to 9 or of the type obtained by the process of any one of claims 11 to 15, on a substrate as an anti-corrosion agent, in preparing polymer films, in a cosmetic composition, in catalysis in particular for automobile exhausts, in lubrication, in ceramics, and in the manufacture of luminophores or in optics.
